(19) United States
(12) Patent Application Publication
(10) Pub. No.: US 2025/0303992 A1
(43) Pub. Date: Oct. 2, 2025

(54) SHOCK ABSORBING DEVICE FOR A MOTOR VEHICLE

(71) Applicant: Flex-N-Gate France, AUDINCOURT (FR)

(72) Inventors: Stéphanie BERGERAT, AUDINCOURT (FR); Mathieu FOUCARD, AUDINCOURT (FR); Lionel BLANC, AUDINCOURT (FR)

(21) Appl. No.: 19/095,555

(22) Filed: Mar. 31, 2025

(30) Foreign Application Priority Data
Apr. 2, 2024 (FR) 2403388

(51) Int. Cl. B60R 19/34

(52) U.S. Cl. CPC B60R 19/34

(57) ABSTRACT

The shock absorbing device (10) is intended to be placed in front of a transverse beam (8) of a vehicle). It includes a first rigid cross member (14), intended to be arranged in contact with said transverse beam (8), and a second cross member (16) with lower rigidity than the first cross member (14), comprising a first part (16a) arranged in front of the first cross member (14), and a second part (16b) extending above the first cross member (14).

The present invention relates to a shock absorbing device intended for a motor vehicle.

A motor vehicle bumper typically includes an external decorative cover, known as a skin, and a shock energy absorbing device, intended to absorb the energy of an impact by deformation, thereby transmitting as little energy as possible to the vehicle.

Various types of impacts are considered when developing a shock absorbing device, such as high-speed impacts corresponding to a frontal impact of the vehicle against a rigid or deformable obstacle at a speed of 56 to 64 km/h, “insurance” impacts such as those known under the name “Danner”, at 15 km/h against a fixed wall, and minor impacts, or “parking” impacts, at a speed of between 4 and 8 km/h. High-speed impacts are considered with the aim of protecting vehicle occupants, while “insurance” and “parking” impacts, in other words, “minor impacts,” aim to reduce repair costs. It is also necessary to consider pedestrian impacts, which respect the leg of a pedestrian in order to limit serious and disabling injuries.

The present invention particularly relates to a shock absorbing device intended for handling minor impacts and pedestrian impacts.

The shock absorbing device is conventionally intended to be placed in front of a transverse beam of the vehicle.

Such a motor vehicle also typically includes a grille, also in front of the transverse beam. More particularly, in the case of a grille comprising lighting parts, it is desired that this grille does not come into contact with the transverse beam during a minor impact (notably a parking or pedestrian impact) in order to preserve these lighting parts.

Thus, the aim of the invention is notably to propose a shock absorbing device able to protect the grille in the event of a minor impact.

To this end, the invention, in particular, has as its object a shock absorbing device for a motor vehicle, intended to be placed in front of the transverse beam of the vehicle, characterized in that it includes:
a first rigid cross member, intended to be arranged in contact with said transverse beam, and
a second cross member with lower rigidity than the first cross member, comprising a first part arranged in front of the first cross member, and a second part extending above the first cross member.

The invention allows the decoupling of the “pedestrian” and “minor impacts” functions. The first rigid cross member acts as a spacer and allows to limit the intrusion of parking impact bumpers (type ECE42 and equivalents). The indentation of the grille is thus limited, so that the grille does not come into contact with the front beam in the event of a minor or pedestrian impact.

The second flexible cross member allows the pedestrian leg impact function to be managed and simultaneously allows to guarantee the repeatability of parking impacts.

A shock absorbing device according to the invention may also present one or more of the following features, taken alone or in any technically feasible combination:
The first cross member is made of injected polyethylene.
The second cross member is made of expanded polypropylene.
The second cross member is overmolded onto the first cross member.
The second cross member is attached to the first cross member, for example, by clipping.
The second cross member includes means for attachment to a vehicle bumper, for example, by means of clipping.
The shock absorbing device includes means for attaching the first cross member to the beam of the vehicle.

The invention also relates to a motor vehicle, including a front transverse beam, characterized in that it includes a shock absorbing device such as defined above, arranged in front of said transverse beam.

Preferably, the motor vehicle includes a grille arranged in front of the beam, the first and second cross members being configured so that, when the first part of the second cross member is compressed, the grille remains away from the beam.

Different aspects and advantages of the invention will be highlighted in the following description, given solely as a non-limiting example, and made with reference to the drawings in which:

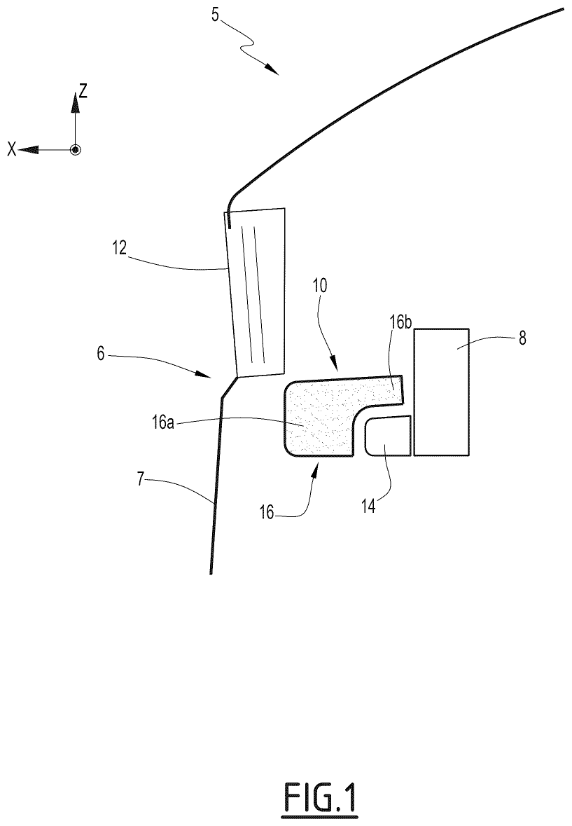

FIG. 1 is a schematic sectional view of a shock absorbing device according to one example embodiment of the invention;

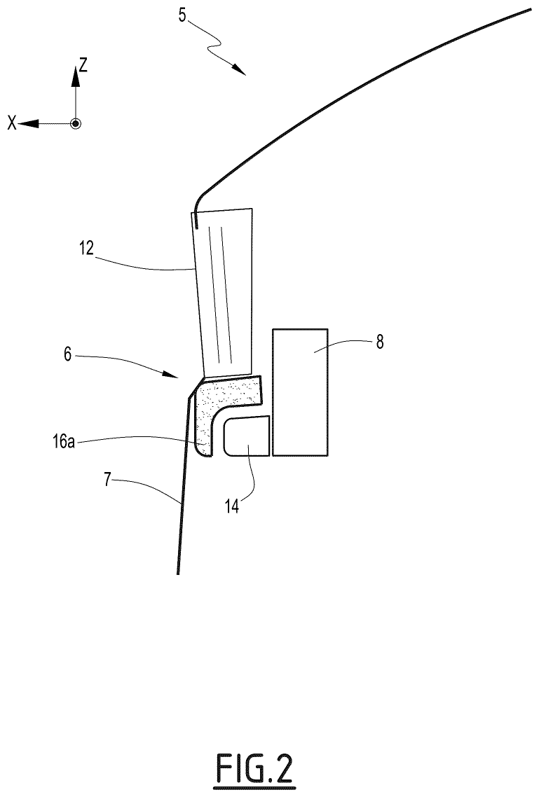

FIG. 2 is a view similar to FIG. 1 of the shock absorbing device after an impact.

The figures show a front zone of a motor vehicle 5. In the present description, the term “front” is to be considered concerning a conventional orientation of the motor vehicle 5, in a longitudinal direction X of the vehicle.

The motor vehicle 5 includes a bumper 6, comprising a classic bumper skin 7, a classic front transverse beam 8, and a shock absorbing device 10 according to one example embodiment of the invention.

The motor vehicle 5 also carries a grille 12. The grille 12 is arranged in front of the transverse beam 8 in the longitudinal direction X. At least part of the grille 12 is at the height of at least part of the beam 8 in a vertical direction Z.

The grille 12 is, for example, of the self-illuminated type and thus carries lighting parts.

The shock absorbing device 10 includes a first rigid cross member 14, intended to be arranged in contact with said transverse beam 8. Preferably, the shock absorbing device 10 includes means for attaching the first cross member 14 to the transverse beam 8.

The first cross member 14 presents sufficient rigidity to remain unalterable in the event of a minor impact, in other words, an impact below 8 km/h. For example, the first cross member 14 presents a Young's modulus greater than 2000 MPa.

The first cross member 14 is, for example, made of injected polyethylene. The polyethylene may, in one alternative, be talc-filled, or in another alternative, talc-free.

The shock absorbing device 10 includes a second cross member 16 with lower rigidity than the first cross member 14 (thus presenting a Young's modulus lower than that of the first cross member 14). For example, the second cross member 16 presents a Young's modulus less than 1000 MPa.

For example, the second cross member 16 is made of expanded polypropylene. Preferably, the weight of the second cross member 16 is between 30 g/l and 60 g/l.

The second cross member 16 includes a first part 16a arranged in front of the first cross member 14 (in other words, aligned in the longitudinal direction X), and a second part 16b extending above the first cross member 14 (in the vertical direction Z).

In accordance with a first alternative embodiment, the second cross member 16 is overmolded onto the first cross member 14.

In accordance with a second alternative embodiment, the second cross member 16 is attached to the first cross member 14, for example, by clipping.

Preferably, the second cross member 16 includes means for attachment to the bumper 6 of the vehicle 5, for example, by clipping means.

The first 14 and second 16 cross members are configured so that when the first part 16a of the second cross member 16 is compressed, the grille 12 remains away from the beam 8, as shown in FIG. 2. To this end, the sum of the dimension, in the longitudinal direction X, of the first cross member 14 and the dimension, in the longitudinal direction X, of the crushed first part 16a, is greater than the dimension of the grille 12 in the longitudinal direction X.

1. A shock absorbing device for a motor vehicle, intended to be placed in front of a front transverse beam of a vehicle, wherein it includes:
a first rigid cross member, intended to be arranged in contact with said front transverse beam, and
a second cross member with lower rigidity than the first cross member, comprising a first part arranged in front of the first cross member, and a second part extending above the first cross member.

2. The shock absorbing device according to claim 1, wherein the first cross member is made of injected polyethylene.

3. The shock absorbing device according to claim 1, wherein the second cross member is made of expanded polypropylene.

4. The shock absorbing device according to claim 1, wherein the second cross member is overmolded onto the first cross member.

5. The shock absorbing device according to claim 1, wherein the second cross member is attached to the first cross member.

6. The shock absorbing device according to claim 1, wherein the second cross member is attached to the first cross member by clipping.

7. The shock absorbing device according to claim 1, wherein the second cross member includes an attachment member for attaching to a vehicle bumper.

8. The shock absorbing device according to claim 1, wherein the second cross member includes an attachment member for attaching to a vehicle bumper by clipping.

9. The shock absorbing device according to claim 1, including an attachment member for attaching the first cross member to the front transverse beam of the vehicle.

10. A motor vehicle, including a front transverse beam, wherein it includes a shock absorbing device arranged in front of said front transverse beam, the absorbing device including:
a first rigid cross member, arranged in contact with said front transverse beam, and
a second cross member with lower rigidity than the first cross member, comprising a first part arranged in front of the first cross member, and a second part extending above the first cross member.

11. The motor vehicle according to claim 10, including a grille arranged in front of the front transverse beam, the first and second cross members being configured so that, when the first part of the second cross member is compressed, the grille remains away from the front transverse beam.
